(19) United States
(12) Patent Application Publication
(10) Pub. No.: US 2010/0216730 A1
(43) Pub. Date: Aug. 26, 2010

(54) SPRAYABLE CONTROLLED-RELEASE, MALE ANNIHILATION TECHNIQUE (MAT) FORMULATION AND INSECT CONTROL

(75) Inventors: Raymond E. Boucher, JR., Lebanon, IN (US); Reginald Coler, Riverside, CA (US); Mark Hertlein, Indianapolis, IN (US); Steve Tuttle, Sanford, MI (US); Agenor Mafra-Neto, Riverside, CA (US)

Correspondence Address: DOW AGROSCIENCES LLC, 9330 ZIONSVILLE RD, INDIANAPOLIS, IN, 46268, US

(73) Assignees: Dow AgroSciences LLC, Indianapolis, IN (US); ISCA Technologies Inc., Riverside, CA (US)

(21) Appl. No.: 12/775,524

(22) Filed: May 7, 2010

Related U.S. Application Data
(63) Continuation of application No. 11/982,915, filed on Nov. 6, 2007.
(60) Provisional application No. 60/857,347, filed on Nov. 7, 2006.

(51) Int. Cl. A01N 43/16; A01P 7/04

(52) U.S. Cl. 514/28

(57) ABSTRACT

A male annihilation insecticide formulation, having a viscosity appropriate for use in aerial or backpack spray applications and suitable for on-crop or off-crop uses, comprises an insect toxicant and a male-specific attractant, such as a parapheromone, for a target insect species, such as fruit fly, dispersed and entrapped in an emulsion comprising a biodegradable wax, an emulsifiers, and water.

### CROSS REFERENCE TO RELATED APPLICATION

This application claims the benefit of provisional application Ser. No. 60,857,347, filed Nov. 7, 2006, the entire contents of which is hereby incorporated by reference. This application claims the benefit of non-provisional application Ser. No. 11/982,915, filed Nov. 6, 2007, the entire contents of which is hereby incorporated by reference.

### FIELD OF THE INVENTION

The present invention provides a sprayable formulation for control of insect populations using male annihilation technique (MAT), and an insect control method using the formulation.

### BACKGROUND OF THE INVENTION

MAT involves use of an insecticide in combination with a male insect attractant, such as a parapheromone. The formulated insecticide is typically placed in a large number of bait stations distributed throughout the area in which control or eradication is desired. MAT works by reducing the male population to an extent that mating is effectively eliminated. MAT is a proven technique, for example, to eliminate fruit flies.

One of the first applications of MAT is described in L. F. Steiner et al., “Oriental Fruit Fly Eradication by Male Annihilation,” J. of Econ. Entomol. 58: 96 (1965), which involved successful eradication of a heavy infestation of oriental fruit fly from the island of Rota, Mariana Islands. In that case, cane-fiber squares were saturated with a solution of methyl eugenol-3% naled and these were dropped from the air or suspended from trees.

MAT requires that the male-specific fruit fly attractant be continually released in effective amounts over an extended time period. It also requires that an effective amount of insecticide is distributed to the male insects that are attracted, and that the insecticide will remain active for an extended period of time after being distributed in the field (residuality). The formulated material must be protected from weathering or be resistant to washoff (rainfast). Typical MAT fruit fly products have heretofore been traps. It would be advantageous to have sprayable MAT product(s) with controlled-release and extended residual properties for both the toxicant and the male-specific attractant, as well as rainfastness, but such formulations have not heretofore been available.

MAT products have typically used organophosphate insecticides, the use of which is highly restricted due to environmental concerns.

Spinosad is an insecticide produced by Dow AgroSciences (Indianapolis, Ind.) that is comprised mainly of approximately 85% spinosyn A and approximately 15% spinosyn D. Spinosyns A and D are natural products produced by fermentation of Saccharopolyspora spinosa, as disclosed in U.S. Pat. No. 5,362,634. The spinosyn compounds consist of a 5,6,5-tricylic ring system, fused to a 12-membered macrocyclic lactone, a neutral sugar (rhamnose), and an amino sugar (forosamine) (see Kirst et al. (1991)). Natural spinosyn compounds may be produced via fermentation from cultures deposited as NRRL 18719, 18537, 18538, 18539, 18743, 18395, and 18823 of the stock culture collection of the Midwest Area Northern Regional Research Center, Agricultural Research Service, United States Department of Agriculture, 1815 North University Street, Peoria, Ill. 61604. Spinosyn compounds are also disclosed in U.S. Pat. Nos. 5,496,931, 5,670,364, 5,591,606, 5,571,901, 5,202,242, 5,767,253, 5,840,861, 5,670,486 and 5,631,155. As used herein, the term “spinosyn” is intended to include natural factors and semi-synthetic derivatives of the naturally produced factors. A large number of chemical modifications to these spinosyn compounds have been made, as disclosed in U.S. Pat. No. 6,001,981, hereby incorporated by reference.

Spinetoram is a semi-synthetic spinosyn insecticide under development by Dow AgroSciences LLC. Spinetoram (also known as DE-175) is the common name for a mixture of 50-90% (2R,3aR,5aR,5bS,9S,13S,14R, 16aS,16bR)-2-(6-deoxy-3-O-ethyl-2,4-di-O-methyl-α-L-mannopyranosyloxy)-13-[(R2R,5S,6R)-5-(dimethylamino)tetrahydro-6-methylpyran-2-yloxy]-9-ethyl-2,3,3a,4,5,5a,5b,6,9,10,11,12,13,14,16a,16b-hexadecahydro-14-methyl-1H-as-indaceno[3,2-d]oxacyclododecine-7,15-dione, and 50-10% (2R,3aR,5aS,5bS,9S,13S,14R,16aS,16b5)-2-(6-deoxy-3-O-ethyl-2,4-di-O-methyl-α-L-mannopyranosyloxy)-13-[(R2R,5S,6R)-5-(dimethylamino)tetrahydro-6-methylpyran-2-yloxy]-9-ethyl-2,3,3a,5a,5b,6,9,10,11,12,13,14,16a,16b-tetradecahydro-4,14-dimethyl-1H-as-indaceno[3,2-d]oxacyclododecine-7,15-dione. Synthesis of the components of spinetoram is described in U.S. Pat. No. 6,001,981.

Macrolide insecticides related to the spinosyns have been isolated from Saccharopolyspora sp. LW107129 (NRRL 30141 and mutants thereof). These compounds are disclosed in U.S. Pat. No. 6,800,614, hereby incorporated by reference. These compounds are characterized by the presence of reactive functional groups that make further modifications possible at locations where such modifications were not feasible in previously disclosed spinosyns. Natural and semi-synthetic derivatives of the butenyl spinosyns are disclosed in U.S. Pat. No. 6,919,464, hereby incorporated by reference. The term “butenyl-spinosyn” as used herein is intended to include natural factors and semi-synthetic derivatives of the naturally produced factors.

The spinosyn and butenyl spinosyn compounds have established utility for the control of arachnids, nematodes, and insects, in particular Lepidoptera and Diptera species. Spinosyns and butenyl spinosyns are active against all commercially relevant fruit fly species. Spinosad is approved for use on more than 150 crops. Spinosad has been recognized as an environmentally friendly insecticide: it was a 1999 award winner in the EPAs Presidential Green Chemistry Challenge.

The commercially available protein bait, GF-120 FRUIT FLY BAIT uses spinosad as the active ingredient. Although sprayable, this formulation is not suitable for MAT applications since it does not contain male-specific attractants and lacks the desired residual or rainfastness properties required for extended control of male insect populations. It is designed as a male/female fruit fly bait spray using food-based attractants.

### BRIEF SUMMARY OF THE INVENTION

The present invention provides a sprayable wax emulsion formulation, having a viscosity appropriate for use in aerial or backpack spray applications and suitable for on-crop or off-crop uses, comprising an insect toxicant (exemplified by a spinosyn natural factor or semi-synthetic derivative or butenyl-spinosyn natural factor or semi-synthetic derivative) and a male-specific attractant (exemplified by male-specific fruit fly parapheromones), in some cases supplemented with a phagostimulant (compound that promotes the oral uptake of a substrate), for use in control of a target insect population using male annihilation technique (MAT). The insect toxicant and male-specific attractant, and other formulation ingredients are dispersed and entrapped in an emulsion of biodegradable wax, emulsifiers, and water. The invention also provides a MAT method for control of a target insect population which comprises spraying the above described formulation at the locus where control is desired. In one embodiment the targeted insect species is fruit fly, the male-specific attractant is a paprapheromone that attracts male fruit flies, and the insect toxicant is a spinosyn or butenyl spinosyn insecticide.

### DETAILED DESCRIPTION OF THE INVENTION

The formulation contains a male-specific attractant in an amount from about 0.01% to 75% by weight. Suitable male-specific attractants are available for a number of potential target species. Examples include but are not restricted to: for oriental fruit fly (Bactrocera dorsalis and related species), methyl eugenol is appropriate; for melon fly (Bactrocera curcubitae) and Queensland fruit fly (Bactrocera tryoni) and related species, cue-lure; for Malaysian fruit fly (Bactrocera latifrons—latilure; for jointed pumpkin fly (Dacus vertebrates)—Vert-lure; for medfly (Ceratitis capitata)—trimedlure or ceralure; for walnut husk fly (Rhagoletis completa)—alpha copaene; for olive fruit fly (Bactocera oleae), spiroketal. These or other male-specific attractants should be directed against the target insect pest and can be selected from many products which are well known in the art, including but not limited to methyl eugenol, cuelure, trimedlure, ceralure, latilure, vertlure, alpha copaene.

The formulation contains one or more insect toxicants (insecticides) in an amount from about 0.002% to about 25.00%. A spinosyn natural factor or semi-synthetic derivative or butenyl-spinosyn natural factor or semi-synthetic derivative is suitable. Spinosad and spinetoram are specific spinosyns that can be used. Other insect toxicants that can be used include but are not limited to oranophosphates, such as naled, carbamates, pyrethroids, nicotinics such as imidacloprid or thiacloprid, benzoylphenylureas such as dimilin or novaluron, diacylhydrazines such as methoxyfenozide, phenylpyrazoles such as fipronil or ethiprole, chlorfenapyr, diafenthiuron, indoxacarb, metaflumazone, emamectin benzoate, abamectin, pyridalyl, flubendiamide, rynaxypyr, or others.

The aqueous wax emulsion utilized in the formulation is broadly described in U.S. Pat. No. 6,001,346, which is hereby incorporated by reference, with the qualification that the material used in the present invention must be made to have a viscosity appropriate for use in aerial or backpack spray applications. SPLAT™ (Specialized Pheromone and Lure Application Technology) aqueous wax emulsions were developed in accordance with U.S. Pat. No. 6,001,346 for the protection and dispensing of semiochemicals (including pheromones and parapheromones). SPLAT emulsions can be applied directly to vegetation, can be formulated in a wide range of viscosities, and are advantageously used in the compositions of the present invention.

The biodegradable wax carrier comprises at least about 10% by weight of the formulation. The biodegradable wax carrier is selected from the group consisting of paraffin, beeswax, vegetable based waxes such as soywax (soybean based), and hydrocarbon based waxes such as Gulf Wax Household Paraffin Wax.; paraffin wax, avg. m.p. 53C (hexacosane), high molecular weight hydrocarbons). carnauba wax, lanolin, shellac wax, bayberry wax, sugar cane wax, microcrystalline, ozocerite, ceresin, montan, candelilla wax, and combinations thereof.

The formulation contains an emulsifier in an amount from about 1% to about 10% by weight. Suitable emulsifiers include lecithin and modified lecithins, mono- and diglycerides, sorbitan monopalmitate, sorbitan monooleate, sorbitan monolaurate, polyoxyethylene-sorbitan monooleate, fatty acids, lipids, etc. The emulsifiers provide or improve emulsification properties of the composition. The emulsifier can be selected from many products which are well known in the art, including but not limited to sorbitan monolaurate (anhydrosorbitol stearate, molecular formula C₂₄H₄₆O₆), ARLACEL 60, ARMOTAN MS, CRILL 3, CRILL K3, DREWSORB 60, DURTAN 60, EMSORB 2505, GLYCOMUL S, HODAG SMS, IONET S 60, LIPOSORB S, LIPOSORB S-20, MONTANE 60, MS 33, MS33F, NEWCOL 60, NIKKOL SS 30, NISSAN NONION SP 60, NONION SP 60, NONION SP 60R, RIKEMAL S 250, sorbitan c, sorbitan stearate, SORBON 60, SORGEN 50, SPAN 55, AND SPAN 60; other sorbitan fatty acid ester that may be used include sorbitan monopalmitate, sorbitan monostearate, sorbitan tristearate, sorbitan monooleate, sorbitan sesquioleate, sorbitan trioleate, sorbitan monooleate, sorbitan trioleate. SPAN 60 is preferred.

In certain embodiments, the formulation includes a phagostimulant, such as corn oil, molasses, glycerol, or corn syrup, proteinaceous material (protein or hydrolyzed protein), sugars like sucrose, or food-based semiochemicals such as trimethylamine, putrescine, bacterial or yeast volatiles or metabolites, ammonium acetate, ammonium carbonate or other ammonia-emitting compounds. Acetic acid vapor can be provided by compounds that produce volatilized acetic acid, for example, aqueous acetic acid, glacial acetic acid, glacial (concentrated) acetic acid, or ammonium producing compounds such as but not restricted to ammonium hydroxide, ammonium carbonate, ammonium bicarbonate, ammonium acetate, etc. Ammonium acetate is most preferred for providing acetic acid and ammonia vapors.

The formulation may contain visual attractants, e.g. food coloring.

A variety of additives may be incorporated into the formulation. These additives typically change and/or enhance the physical characteristics of the carrier material and are, therefore, suitable for designing compositions having specific requirements as to the release rate and amount of the released semiochemicals/attractants and/or repellents, protection of the wax composition from weather conditions, etc. These additives are, among others, plasticizers, volatility suppressants, antioxidants, lipids, various ultraviolet blockers and absorbers, or antimicrobials, typically added in amounts from about 0.001% to about 10%, more typically between 1-6%, by weight.

Plasticizers, such as glycerin or soy oil affect physical properties of the composition and may extend its resistance to environmental destruction.

Antioxidants, such as vitamin E, BHA (butylated hydroxyanisole), BHT (butylated hydroxytoluene), and other antioxidants which protect the bioactive agent from degradation, may be added in amounts from about 0.1% to about 3%, by weight.

Ultraviolet blockers, such as beta-carotene or p-aminobenzoic acid protect the bioactive agents from light degradation may be added in amounts from about 1% to about 3%, by weight.

Antimicrobials, such as potassium sorbate, nitrates, nitrites, and propylene oxide, protect the bioactive agents from microbial destruction may be added in amounts from 0.1% to about 2% by weight.

Other compounds and materials may be added provided they do not substantially interfere with the attractant activity of the composition of the invention. Whether or not an additive substantially interferes with the attractant activity can be determined by standard test formats, involving direct comparisons of efficacy of the composition of the present invention without an added compound and the composition of the present invention with an added compound.

Bactrocera and Ceratitis species of fruit flies are used as a model system in the examples below. However, the system is applicable to the control of other fruit flies or other insects or arthropods for which a male attractant is known or becomes known and available. One of ordinary skill in the art can readily determine an appropriate insect attractant to attract specific insect populations.

### EXAMPLE 1

Sprayable MAT formulation for Bactrocera spp., exemplified by Oriental fruit fly
53% methyl eugenol a.i. (500 g/Kg)
2.2% technical spinosad a.i. (20 g/Kg)
15% microcrystalline wax
10% soy oil
16.8% water
3% SPAN 60

Suitable sprayable MAT formulations similar to Example 1 can be made using 30-70% methyl eugenol and 5-20% spinosyn or butenyl spinosyn.

### EXAMPLE 2

Sprayable MAT formulation for Bactrocera spp. exemplified by Melon fly
30% Cuelure a.i. (200 g/kg)
2.0% tech spinosad a.i. (22 g/kg)
25.0% microcrystalline wax
5% soy oil
33.0% water
5.0% SPAN 60

### EXAMPLE 3

Sprayable MAT formulation for Ceratitis spp exemplified by med fly
30% Trimedlure a.i. (300 g/kg)
2.2% tech spinosad a.i. (22 g/kg)
25% microcrystalline wax
10% soy oil
29.7% water
3% SPAN 60

### EXAMPLE 4

Sprayable MAT formulation for Bactrocera dorsalis (Oriental fruit fly)
50% methyl eugenol a.i. (500 g/kg)
2% technical spinosad a.i. (20 g/kg)
16% microcrystalline wax
12% soy oil
17% water
3% SPAN 60

The residual efficacy of the formulation of Example 4 was tested at multiple locations in an outdoor setting under ambient Hawaii weather conditions. Performance of the formulation was equivalent to or superior to a comparative MAT standard (Minugel-Naled-methyl eugenol, which is a formulation used by California in fruit fly eradication programs) during exposure periods up to 12 weeks. The formulation of Example 4 demonstrated practical utility for oriental fruit fly control out to 4-5 weeks.

### EXAMPLE 5

Sprayable MAT formulation for Bactrocera cucurbitae. (Melon fly)
20% Cuelure (200 g/kg)
2% tech spinosad (20 g/kg)
15% fructose
21% microcrystalline wax
15.75% soy oil
22.31.% water
3.94% SPAN 60

The residual efficacy of the formulation of Example 5 in control of Bactrocera cucurbitae was evaluated in field trials in Hawaii. The treatments were exposed to ambient temperatures and rainfall and were found to be effective. A similar formulation containing naled (1,2-dibromo-2,2-dichloroethyl dimethyl phosphate) in place of spinosad was tested along with the spinsoad formulation, and the naled/cuelure/SPLAT formulation was also effective. For both formulations, weathered treatments were equivalent to fresh treatments for 14 to 21 days, depending on location.

### EXAMPLE 6

Sprayable MAT formulation for Ceratitis capitata (med fly)
50% Trimedlure (500 g/kg)
2% tech spinosad (20 g/kg)
15% fructose (150 g/kg)
11% microcrystalline wax
8.25% soy oil
11.69% water
2.06% SPAN 60

The residual efficacy of the formulation of Example 6 in control of Ceratitis capitata was evaluated in field tests wherein the treatments were weathered outdoors under ambient conditions in Spain. The formulation demonstrated 89%, 95%, 50%, 57%, and 20% male medfly mortality at the 0,1,2,3, and 4 week weathering timepoints, respectively.

The inert ingredients in the formulations of the present invention are typically formulated by mixing the biodegradable paraffin or microcrystalline wax, in amounts from about 10% to about 90%, preferably about 30-40%, depending on the type of the wax and on the desired properties of the coating, with from about 5% to about 90% of water, preferably about 50% of water. To this SPLAT composition are added the male-specific attractants and/or phagostimulants, each in an amount from about 0.01% to about 70%, preferably about 5% to about 20%. Additives or other bioactive agents may be optionally added in amounts from about 0.001% to about 20%, preferably in an amount from about 0.1% to about 10%, depending on the additive or the bioactive agent. The ratio of the carrier wax/water/attractants and insecticide is adjusted to give a viscosity appropriate for conventional spray equipment.

To formulate the composition, heat the basic ingredients i.e. paraffin or microcrystalline wax, emulsifiers (e.g., sorbitan monostearate) and water to a liquid state thoroughly mix contents to create an emulsion. Add to the emulsion phagostimulants such as oil or sugar (e.g., glycerol, corn syrup or granulated sugar), optionally an effective amount of an insect visual attractant (e.g., green food coloring (McCormick & Co., Hunt Valley, Md.)), optionally an effective amount of preservatives, anti oxidants, UV stabilizers, and insect chemical attractants (e.g., methyl eugenol), and the insecticide (e.g, spinosad or spinetoram). Cool the mixture. Once the formulation reaches room temperature it can be transferred into the final packaging.

Another key aspect of the invention is that it constitutes a sprayable use pattern for MAT fruit fly products which is unique and potentially much more effective than current MAT products, which are traps requiring replacement or servicing. Having a wide range of viscosities and application methods (e.g. applicator sprays, aerial applicator sprays, caulking gun type tubes, etc.) SPLAT increases productivity by mechanizing the application of pheromone dispensing points. Additionally, the SPLAT matrix provides flexibility when applying the active ingredient per unit area. That is, depending on the concentration used: a fixed quantity of this material can be applied differently depending on the pest population pressure. The application of this matrix can be tailored by the user to best match the pest distribution and density in the field. Using a fixed amount of SPLAT per area, one can choose: either a high density of small point-sources, thus maximizing the mating disruption effect (recommended for high pest pressure); or a low density of larger point-sources, thus increasing the longevity of the application (recommended for lower pest population pressure). The sprayable MAT product provided by the invention can conveniently and cost-effectively deliver many more point sources of the MAT product without necessarily increasing the amount of material applied per unit area, thus vastly increasing the protection of a treated area and the numbers of males controlled. This invention would be capable of being sprayed to on-crop and/or off-crop habitats of the targeted insect pests.

The unique and convenient sprayable use pattern of this invention, combined with its controlled release properties for both the insecticides and male-specific attractant it contains, and the rainfastness of the formulation distinguishes it from all prior and current MAT products. Briefly, the composition of the invention is sprayed using conventional spray equipment, such as tractor sprayer, backpack sprayer, or lawn sprayer equipment. In a particular embodiment, the formulation is sprayed from the air using conventional crop spraying aircraft to provide area-wide control. In general the formulation is thereby sprayed directly to or on the treated areas or surfaces, such as orchards, gardens, plants, trees or soil. The application rate is 1 to 40 liters per hectare. A typical application rate is 1-5 liter per hectare.

The sprayable MAT insect baiting system described herein, once applied, creates long lasting point sources that are spatially discrete, attract targeted pest insects, and provide effective control without harming non-target organisms. One key advantage of the invention is that the insect baiting system is much longer lasting when exposed to ambient environmental conditions. For example, it will kill attracted insects for approximately three weeks during times of considerable rain (the term “rainfast” in the claims refers to this property) and at least two months under dry conditions (the term “controlled release” in the claims refers to this property). This has not been possible using previous formulations.

In summary, the invention provides a sprayable, rainfast, controlled release, Male Annihilation Technique (MAT) insecticide formulation, having a viscosity appropriate for use in aerial or backpack spray applications and suitable for on-crop or off-crop uses, comprising an insect toxicant and a male-specific attractant for a target insect species dispersed and entrapped in an emulsion comprising a biodegradable wax, an emulsifier, and water.

1. A method for controlling one or more fruit fly species said method comprising spraying a rainfast controlled released formulation wherein said formulation consists essentially of:
a. an insect toxicant, wherein said insect toxicant is either spinosad or spinetoram, and wherein said insect toxicant is from about 0.002% to about 25.00% by weight of said formulation;
b. methyl eugenol, wherein said methyl eugenol is from 30% to 70% by weight of said formulation
c. biodegradable wax carrier, wherein said biodegradable wax carrier is from about 10% to about 90% by weight of said formulation;
d. an emulsifier, wherein said emulsifier is from about 1% to about 10% by weight of said formulation;
e. a plasticizer, wherein said plasticizer is either glycerin or soy oil, and wherein said plasticizer is from about 0.001% to about 20% by weight of said formulation;
f. water, wherein said water is from about 5% to about 90% by weight of said formulation.

2. A method according to claim 1 wherein said amount of insect toxicant is 2%.

3. A method according to claim 2 wherein said amount of methyl eugenol is 50%.

4. A method according to claim 3 wherein said amount of biodegradable wax carrier is 16%.

5. A method according to claim 4 wherein said amount of emulsifier is 12%.

6. A method according to claim 5 wherein said amount of plasticizer is 3%.

7. A method according to claim 6 wherein said amount of water is 17%.
